(19) United States
(12) Patent Application Publication
(10) Pub. No.: US 2014/0023767 A1
(43) Pub. Date: Jan. 23, 2014

(54) Oxygenating drinking/mixing vessel

(71) Applicant: Michael J. Dikas, San Carlos, CA (US)

(72) Inventor: Michael J. Dikas, San Carlos, CA (US)

(21) Appl. No.: 13/986,964

(22) Filed: Jun. 18, 2013

Related U.S. Application Data
(60) Provisional application No. 61/661,281, filed on Jun. 18, 2012.

(51) Int. Cl. B01F 3/04

(52) U.S. Cl. CPC B01F 3/04808
USPC 426/474; 261/125; 29/469

(57) ABSTRACT

A vessel design for the aeration of coffee, tea, spirits, wine, or mixing liquids/powders has a uniquely engineered system of lateral, horizontal and vertical peaked petal shaped ridges on the inside at specific angles, shapes, and heights. When liquid is swirled over the ridge pattern, friction is created both internally and externally in the resulting vortex, adding oxygen and releasing volatile organic chemicals, creating an optimally mixed, better tasting consumer experience. Vessel design allows a user to swirl as much or as little as desired to affect the mixing process. The present invention has substantial and beneficial effects on the taste of coffee, tea, wine, spirits, and a variety of liquid/powder beverages.

### CROSS REFERENCE AND RELATED APPLICATIONS

This application claims priority under 35 USC 119 from U.S. Provisional Application No. 61/661,281 filed on Jun. 18, 2012 and titled AERATING DRINKING VESSELS FOR COFFEE, TEA, WINE, SPIRITS the entire disclosures of which are incorporated herein by reference.

### FIELD OF THE INVENTION

The present invention relates specifically to vessels with a specific shape and pattern of petals protruding on the inside and, more specifically, to ceramic, glass, metal and plastic drinking and mixing vessels having the means to more effectively mix powders/liquids and improve the taste/texture of coffee, tea, spirits and wines.

### BACKGROUND

Black coffee, tea, spirits, wines are almost always too bitter or too sweet when first poured and most consumers don't have the time, equipment or inclination to decant the liquids, allowing oxygenation to reduce the bitter or sweet elements. Furthermore, aftermarket aeration devices are too dangerous to use with hot liquids like coffee or tea, and do not provide enough oxygenation to affect the flavor of spirits or younger popular wines. These liquids would require multiple passes through an aerator and the process is not viable once the initially aerated liquid is in a glass. Coffee and tea consumers seeking a smoother drink typically add milk or cream to counter the inherent bitter taste. This adds both calories and expense.

Numerous beverage containers have been developed for the purpose of drinking, tasting and aerating wine or spirits. None of these vessels take into consideration the forces of nature—gravity, air pressure, temperature—the established characteristics of a vortex, the Newtonian laws of motion and fluid dynamics, or the molecular composition of the liquids in question. The known vessels do not aerate or alter the molecular structure of coffee, tea, or spirits. Examples of known structures are disclosed in, for example, US Patent Application Publication No.: US2008/0290102 (Mangano), which offers a small single protrusion with tiny holes on the bottom of the vessel that liquid would actually spin around during the course of normal swirling, negating any aerating effect. Another example includes US Patent Application Publication No.: US2006/0249518 (Festa), which offers one large protrusion of indeterminate size on the inside of the vessel wall, which is not slender and does not offer any resistance or movement of the liquid to the bottom or the center of the vortex or bottom of the vessel where a majority of the aeration physically takes place. US Patent Application Publication No.: US2009/0212053 (Lardino) is another example that offers a series of small cylinders and balls up the inside wall of a wine glass that would actually prohibit the creation of a vortex and would be impossible to manufacture.

Vessels for mixing powders and liquids like Kool-Aid or chocolate milk require a stirring device to thoroughly dissolve the powder in the liquid base. Likewise, when powders are combined with multiple liquids, like oil and vinegar in a salad dressing, vigorous stirring is required and the process is never 100% efficient.

Therefore, what is needed is a system and method for manufacturing a vessel design for the effective aeration of liquids, such as coffee, tea, spirits, wine, and the mixing of powders/liquids.

### SUMMARY OF THE INVENTION

An improved vessel design for the aeration of coffee, tea, spirits, wine, and mixing of liquids/powders has a unique system of lateral, horizontal and vertical peaked petal shaped ridges on the inside at specific angles, shapes, and heights. When liquid or mixture is swirled over the ridge pattern, friction is created both internally and externally in the resulting vortex, adding oxygen, melding the ingredients and releasing volatile organic chemicals, creating a more effectively mixed liquid, and a better tasting consumer experience. Vessel design allows a user to swirl as much or as little as desired to affect the softening/mixing process. The present invention has substantial and beneficial effects on the taste of coffee, tea, wines and spirits, and the mixing of powders/liquids.

The configuration of the pattern in the present invention encourages countercurrent air contact with vertical ridges but then forces the liquid down to the bottom of the vessel with horizontal and down-facing ridges that increase the velocity in the vortex and bring about molecular collisions inside the mass of liquid. This in turn creates air bubbles at the bottom of the vessel that rise again to the top in the swirling vortex. These bubbles are continually exposed to fresh liquid surfaces from absolute bottom to top, providing maximum exposure to the liquid in the vessel per unit volume of air. Greatest efficiency is achieved when liquid flow is countercurrent to the rising air bubbles. None of the prior art attempts to perform in this manner or attempts to achieve true aeration or optimal mixing.

### BRIEF DESCRIPTION OF THE DRAWING

FIG. 1 shows a front view and top view of a mug as may be employed in accordance with certain aspects of the present invention.

FIG. 2 shows an exploded front view of the mug of FIG. 1, detailing the method of manufacturing in accordance with various aspects of the present invention.

FIG. 3 shows a front view and top view of a wine glass as may be employed in accordance with certain aspects of the present invention.

FIG. 4 shows an exploded front view of the wine glass detailing the method of manufacturing.

FIGS. 5A and 5B show examples of production drawings with sample dimensions for two vessel configurations.

### DETAILED DESCRIPTION

The present invention, which can also be built as a ceramic, metal or plastic travel coffee mug with lid, as a Japanese Sake decanter, or as a general mixing carafe for powdered drinks, cocktails, or salad dressings, offers a specific, tested, lattice pattern with peaked petals that are designed to alter the chemical makeup of the liquid in the vessel. As opposed to the prior art cited, the present invention can be tooled and manufactured in volume.

The method of tooling and product assembly is unique to these products. Rheology is the study of the flow of matter, primarily in the liquid state. It applies to substances which have complex molecular structures such as fluid suspensions and polymers, including foods, additives, and biological materials (e.g. blood). Coffee, wine, and spirits are such fluid suspensions, where on average, coffee is 98.5% water, wine is 86% water and spirits such as whiskey, tequila and vodka are 60% water.

A small group of fluids, like water, are known as Newtonian fluids where the viscosity of the liquid will change with temperature, but not with the flow rate or strain rate. Since coffee and wine are largely water, they behave like water. The opposite would be an instant pudding, a powdered solid suspended in liquid that gets more viscous as it is stirred.

Theoretical rheology can determine the effect of external forces and torques (such as the fluid hitting an obstacle like a peaked petal) and internal stresses (molecular collisions) on Newtonian fluids. Given the nature of the vortex as created in the present invention (where the highest velocity of the flow is at the center), it is the goal of the inner-protruding pattern to force the body of liquid toward the vessel's vertical axis and down to the base of the vessel to maximize molecular friction. Air pressure and gravity support this downward movement and increase the saturation of dissolved oxygen in the liquid base. Particle size in the suspended fluid (coffee, tea, wine, spirits, or powdered mixes) determines how much friction and kinetic energy are created during a flow. This kinetic energy will convert to heat in liquids that are below the ambient air temperature—raising the temperature of a chilled white wine and releasing aromatics. No change in acidity or reduction of tannins happens in this process. Oxygen atoms are scientifically proven to be very reactive and aren't particularly choosey about what they react with. So it's reasonable to expect oxygen to assist in mixing powders/liquids and breaking down the flavor compounds in coffee, wine and spirits into some that can be more easily dissolved in water.

Oxidation can also break down the complex sugars like polysaccharides in coffee resulting in simpler more soluble sugars that we can taste. The present invention maximizes the effects of oxidation in coffee, wine, tea, and spirits. In fluid dynamics, slender-body theory is a methodology that can be used to take advantage of the predictable flow around an obstruction to obtain a net effect on the surrounding field. The obstructions on an inner-protruding pattern in an aerating container have to be continuous, slender, and peaked to force the swirling liquid to the center of the vessel without disrupting or defeating the vortex. In accordance with the various aspects of the present invention, this eliminates singular, round, or other shaped/angled protrusions from the ideal vessel design.

The forces of gravity on a liquid mass in a vortex and the nature of the vortex itself will predict that over 80% of the mass will be at the bottom of the vortex and vessel design at a given time. Any pattern of protrusions not including downward facing ridges at the bottom of the vessel will minimize the force and action of the vortex, compromising any aerating properties. Acids found in the plants used to create coffee, wine, tea and spirits are there to protect the plants in nature from predators. These acids also contribute to the fundamental flavor components of the beverages made from the plants. Often, chemicals are sprayed on the plants to help protect them even further. For example, sulfur dioxide is used in wine growing as both an antimicrobial agent to help protect the vines and as an antioxidant. The bulk of sulfur compounds in wine are formed during fermentation. While all fermentations result in some sulfur compounds, yeasts that are starved for nitrogen will produce significantly more sulfur-bearing molecules. During the process of converting sugar to alcohol, yeasts require some nitrogen to reproduce. Once the available nitrogen in a must or juice is exhausted, the yeast will break down amino acids, including sulfur-containing amino acids cysteine and methionine. The byproduct of this breakdown is hydrogen sulfide (H2S), which smells like rotten eggs. Beyond their impact on aroma, sulfur like odors (SLO's) can negatively impact wine mouth feel. Excessive SLO's can contribute a mineral or bitter taste to the wine and can also add astringency. Aeration via swirling in the present invention releases SLO's in wine and other protective and processing chemicals including phenolic compounds in coffee/tea, and ethanol in spirits. Powders designed to break down with heat or stirring in a liquid base will mix more thoroughly under the forces of an ideal vortex.

Mouth feel is a fluids' physical and chemical interaction in the mouth, an aspect of food rheology. It is a concept used in many areas related to the testing and evaluating of foodstuffs, such as wine-tasting and rheology. It is evaluated from initial perception on the palate, to first bite, through mastication to swallowing and aftertaste. In wine-tasting, for example, mouth feel is usually used with a modifier (big, sweet, tannic, chewy, etc.) to the general sensation of the wine in the mouth. Some people, however, use the traditional term, “texture”. Mouth feel is often related to a product's water activity, hard or crisp products having lower water activities and soft products having intermediate to high water activities.

Oxidizing coffee, wine, tea, and spirits via the present invention while removing harsh chemical byproducts creates a softer, enhanced mouth feel. In effect, aerating with the present invention is addition by subtraction. The process doesn't chemically alter tannins, but as undesirable compounds dissipate, fruit flavors seem to intensify, giving the impression of softened structure. It's often the case in coffee and wine that the presence of one compound influences the way another is perceived. For example, a late-harvest wine (loaded with sugar) may still taste relatively dry if it has significant levels of acidity to balance the sweetness. In the same way, mixing powdered chocolate with milk in the present invention results in a thicker, more unified product.

Organic acids play an important role in the development of flavor in several consumer beverages. In coffee for example there are over 30 organic acids that are the result of roasting and which ultimately play an important role in our ability to perceive acidity. Although there are a number of acids that work in synergy to create a coffee's unique profile, there is one acid—quinic acid—that plays a particularly important role. Quinic acid concentrations are relatively low in green coffee beans when compared to that of citric or even malic acid. But, during the roasting process there is a significant increase in quinic and caffeic acid. With an intensely bitter/sharp characteristic, excessive acid in coffee is detrimental to quality. Oxidation created by use of the present invention reduces the perception of quinic acid and releases aroma components.

During the aging process, the perception of acidity in a wine or spirit like scotch may change even though the total measurable amount of acidity is more or less constant throughout the life of the product. This is due to the esterification of the acids, combining with alcohols in complex array to form esters. In addition to making a wine or scotch taste less acidic, these esters introduce a range of possible aromas. These aromas in aged wine and scotch are released and enhanced by use of the present invention.

A drinking vessel made from glass, ceramic, metal or plastic with a specific system of diagonal, vertical and horizontal ridges on the inside of the vessel, can be used to swirl the liquid in a circular motion, forcing the mass downward, releasing volatile organic compounds and resulting in a better taste experience. Mixing fluids and dissolving solids where the solids never fully dissolve typically results in residual solids at the base of the vessel. Swirling this mass in the present invention optimizes the re-mixing of the liquid and solid.

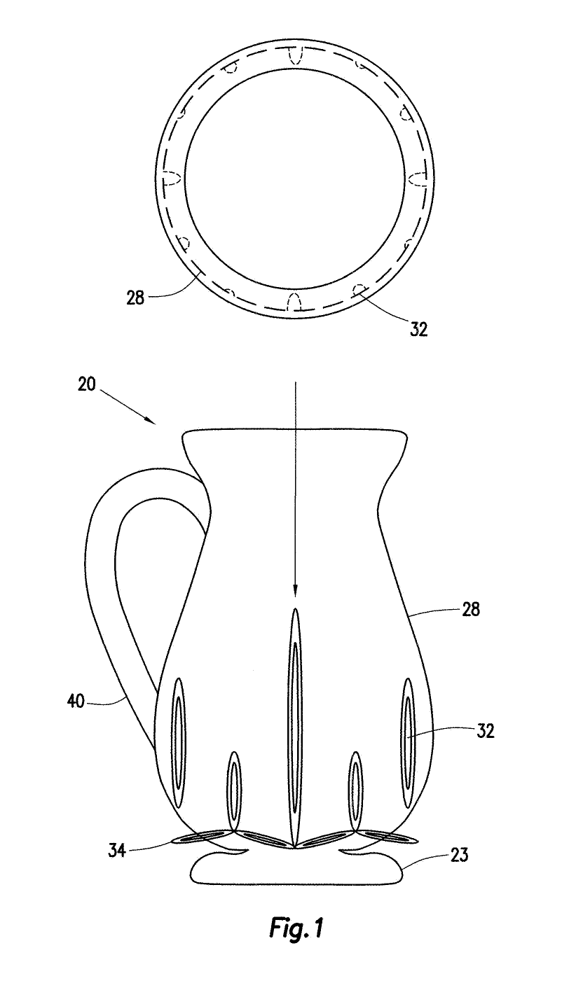

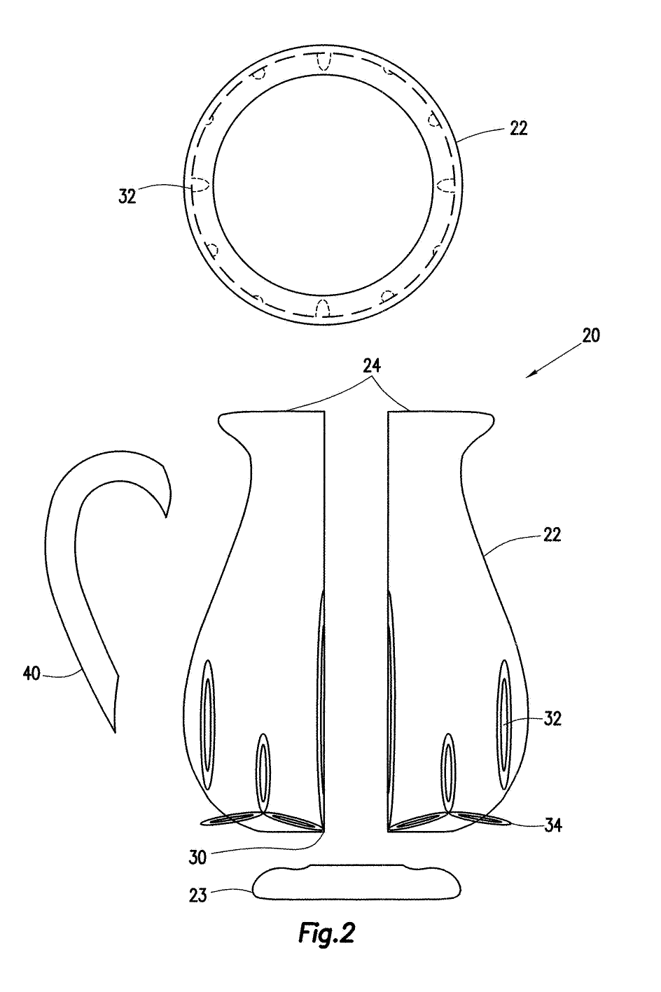

The present invention provides an aerating vessel that enhances the flavors of coffee, tea, spirits and wine when the liquid is swirled. Referring now to FIG. 1 a mug 20 is shown in accordance with the teachings of the present invention. The mug 20 optimizes molecular collisions in the fluid to release volatile organics during swirling. The mug 20 includes a bowl 22, handle 40 and base 23, which are built as separate pieces as shown in FIG. 2 and assembled to form the mug 20.

In accordance with one aspect of the present invention, the bowl 22 features a pattern of slender vertical peaked petals 32 and base horizontal peaked petals 34 that protrude from the inner surface 28, as shown in FIG. 1, of the bowl 22 at opposing twenty-two (22) degree angles. The vertical peaked petals 32 are, in accordance with one aspect of the present invention, 5 mm wide and 3 mm deep at the peak. In accordance with one aspect of the present invention, the horizontal peaked petals 34 are similar in size to the vertical peaked petals 32. As the liquid is swirled, it passes over and through the protrusions, such as vertical petals 32 and horizontal petals 34, to effect aeration. The vertical peaked petals 32 ensure that the vortex created when swirling is not interrupted and the horizontal peaked petals 34 ensure that the liquid at the bottom of the bowl 30 is forced down to maximize molecular collisions. The shape of the bowl 22 is optimized so that the coffee will form a perfect vortex when swirled and will not spill out the top of the vessel. The handle 40 is alternatively used for both drinking and swirling.

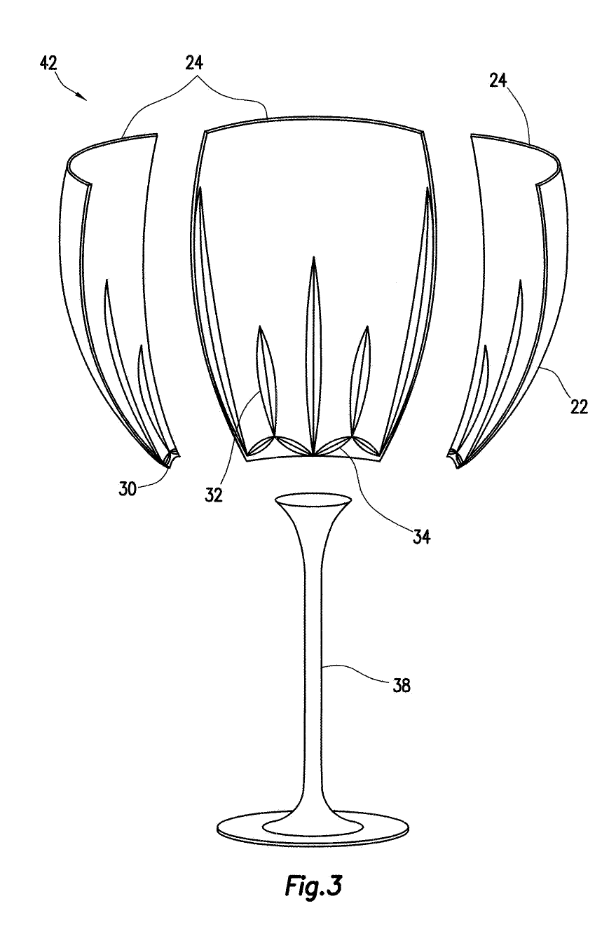

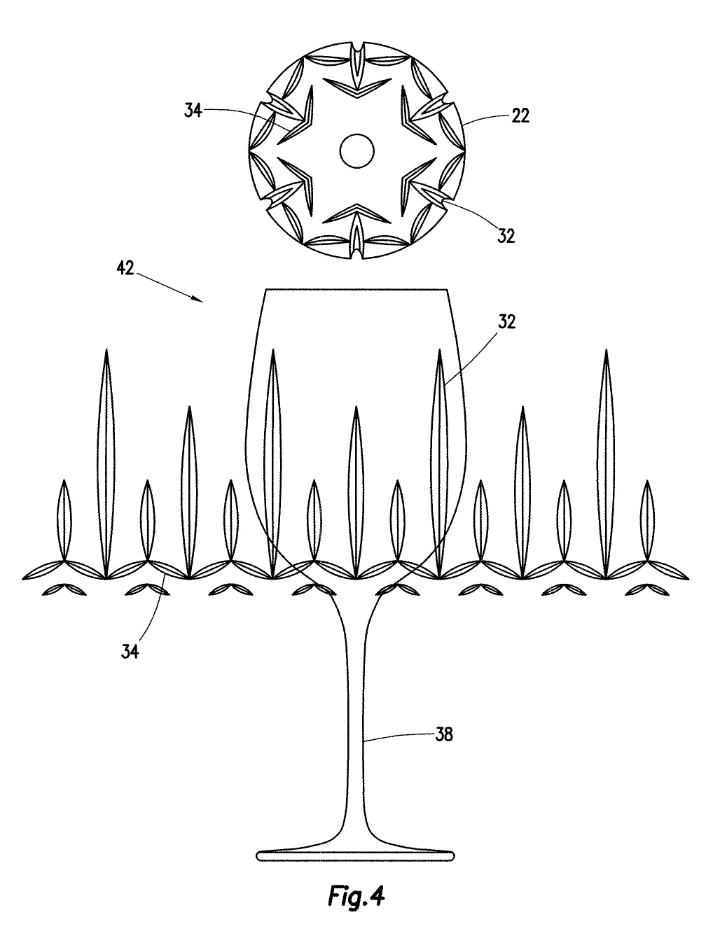

Referring now to FIG. 3, in accordance with another aspect of the present invention, a glass 42 is shown that optimizes molecular collisions in the fluid to release volatile organics during swirling. The wine glass includes a bowl 24, a stem 38, which are built as separate pieces in accordance with one aspect of the present invention as shown in FIG. 4 and assembled to form the glass 42. Some aspects of the present invention are built in parts and hand-assembled.

The bowl 24 features a pattern of slender vertical and base peaked vertical petals 32 and horizontal petals 34 that protrude from an inner surface 28 of the bowl 22 at opposing twenty-two (22) degree angles. The vertical petals 32 ensure that the vortex created when swirling is not interrupted and the horizontal petals 34 ensure that the liquid at the bottom of the bowl 24 is forced down to maximize molecular collisions. The shape of the bowl 24 is optimized so that the wine will form a perfect vortex when swirled and will not spill out the top of the glass 42 or the vessel. The stem/base 38 is alternatively used for both drinking and swirling. The examples given include the base peaked horizontal petals 34 at opposing twenty-two degrees. In accordance with one aspect of the present invention, the optimal angling of the petals 34 is twenty-two degrees. The scope of the present invention is not limited by the opposing angle degree. Thus; in accordance with various aspect of the present invention, a wider range of angles will provide various amounts of aeration. Therefore, the present invention may be construed to include petals 34 angled from ten (10) to thirty-five (35) degrees, more preferably from fifteen (15) to thirty (30) degrees, most preferably from twenty (20) to twenty-five (25) degrees, with 22 degrees being considered optimal.

In accordance with the various aspects of the present invention, the pieces of the vessel may be formed of any suitable material, including, but not limited to glass, ceramic, plastic and metal. The pieces are created by any suitable manufacturing method, current designs are tooled and hand assembled to assure alignment of the protrusions 32, 34.

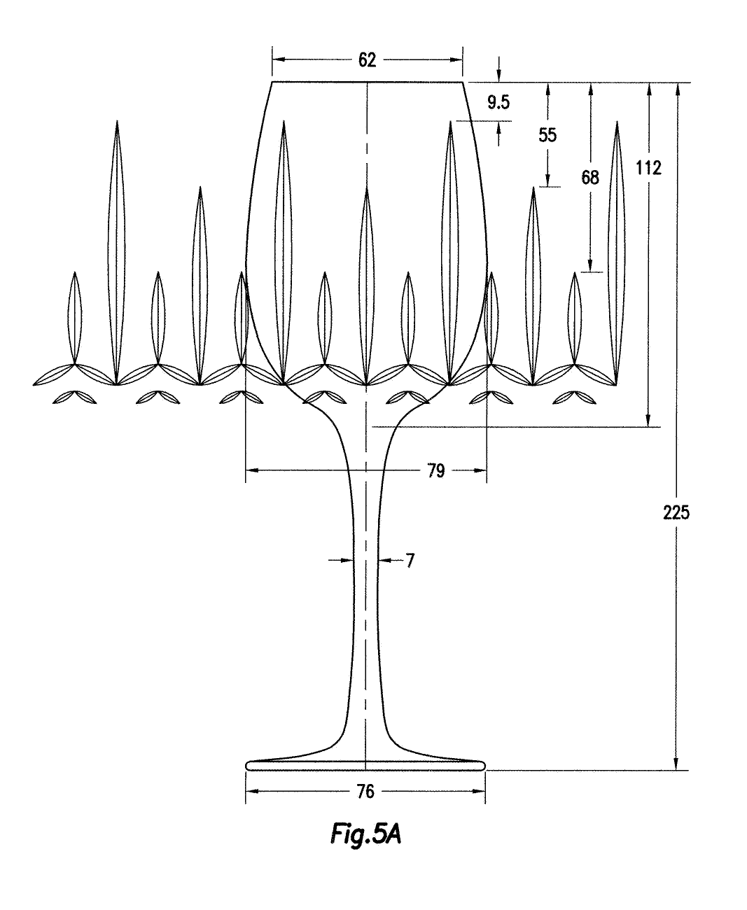

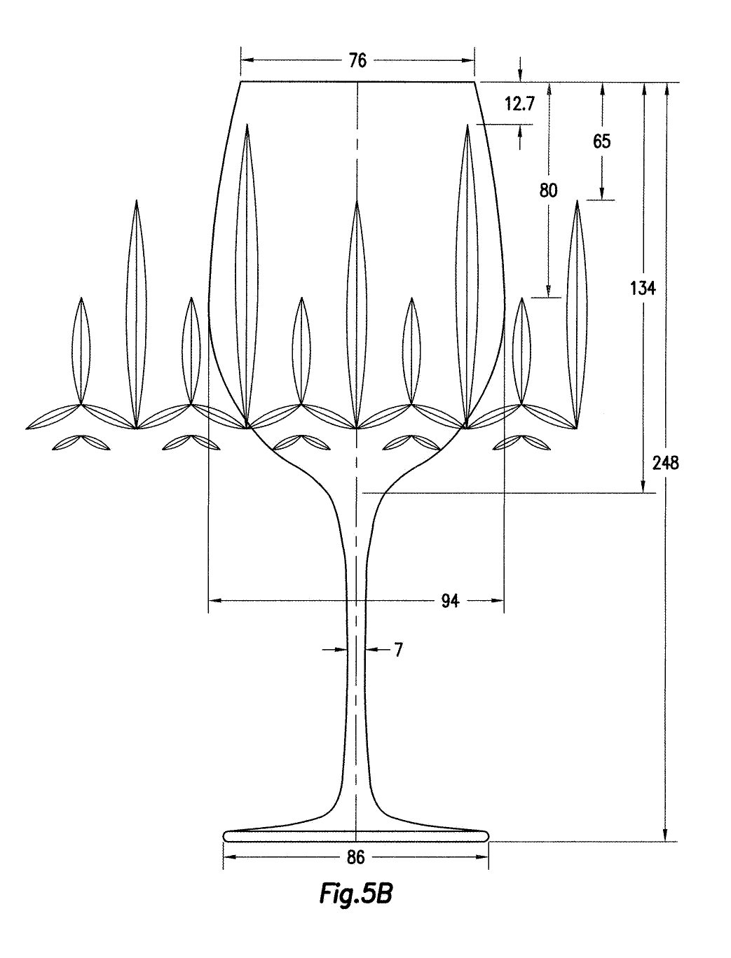

FIGS. 5A and 5B show examples of production drawings with sample dimensions for two vessel configurations for wine glasses.

In operation, one fills the mug, glass or mixing vessel with liquid and rotates it in a circular manner to create a vortex. If the bottom of a vessel is not flat, a vortex can be created in a body of resident liquid by rotating the vessel in a small circular motion. This vortex can be seen as the spiraling motion of air and liquid around a center of rotation. In non-technical terms, the fluid near the center of the vortex circulates faster than the fluid far from the center. The speed along the circular path of flow decreases as you move out from the center. At the same time the inner streamlines have a shorter distance to travel to complete a ring. From a chemical perspective, the collision of molecules that release sulfides and add oxygen primarily takes place inside the mass of liquid, not at the perimeter.

Obstructions placed on the perimeter can deter or completely defeat the flow of a vortex (ref all prior art) minimizing molecular collisions and aeration. If they are too large, too close together, a shape that inhibits flow or not designed to force the liquid in the vessel to the center of rotation and down to the base, aeration is minimal and functionally equal to the same effect as not swirling at all.

In its application with coffee (which is 98.5% water) and wine (which is on average 85% water), swirling in these vessels will add oxygen and release soluble solids. The liquid will return to a stable state once swirling has stopped. Contrary to the claims in prior art, there is no change in acidity (“tannins” in wine) or reduction in pH as a result of swirling. There is however, a minor release of aldehydes and alcohol-related compounds due to oxidation. Swirling can be repeated and the effects on the resident liquid become cumulative.

The swirling process and resulting vortex reduces the temperature of hot coffee and raises the temperature of cold wine, releasing the smells of both the liquid by-products and the basic soluble solids. So after the release of chemical by-products, coffee and wine can smell better than they did in their prior state. As is the case with oxygenated water, the addition of oxygen and release of by-products tastes less bitter on the sides of ones tongue and less bitter in the back, when in fact there is no change in acidity.

The present invention is drawn to a series of vessels having a bowl or body with an interdependent pattern of peaked petals protruding on the inside thereof that optimize the collision of air and liquid molecules, a stem or handle which enables the acute rotation of said bowl or body. Aspects include but are not limited to: coffee mugs; travel coffee mugs; wine glasses; decanters; sake sets; liqueur glasses; shot glasses, and mixing vessels of all kinds.

In accordance with various aspects of the present invention, a vessel comprising the features herein, is built with a proprietary method whereby identical halves or thirds of the bowl or body are made individually with a machined tool and hand assembled to complete a finished product.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof.

Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A vessel for holding a liquid and promoting aeration/mixing thereof, the vessel comprising:
a first bowl piece;
a second bowl piece;
a plurality of vertical protrusions extending inward from an inside surface of the first bowl piece and the second bowl piece; and
angled protrusions extending inward from an inside surface of the first bowl piece and the second bowl piece,
wherein the first bowl piece is connected to the second bowl piece to form the bowl of the vessel.

2. The vessel of claim 1, further comprising a base, wherein the base is connected to the bowl.

3. The vessel of claim 2, wherein the vessel takes the form of a coffee cup.

4. The vessel of claim 3 further comprising a handle connected to the coffee cup.

5. The vessel of claim 2, wherein the vessel takes the form of a wine glass.

6. The vessel of claim 2, wherein the angled protrusions are angled in the range of 20 and 25 degrees.

7. The vessel of claim 2, wherein said angled protrusions are angled at 22 degrees.

8. A method of aerating a beverage, comprising the steps of:
pouring a beverage into a vessel comprising:
vertical protrusions extending vertically inward from an inside surface of the vessel; and
angled protrusions extending inward from an inside surface of the vessel; and
swirling the beverage around within the vessel, wherein passing of the beverage over the vertical protrusions and angled protrusions results in a vortex, thereby aerating the beverage.

9. A process of manufacturing a vessel for aerating a beverage, the process comprising the steps of:
creating at least two bowl pieces, each piece including:
a plurality of vertical protrusions extending inward from an inside surface of each bowl piece; and
a plurality of angled protrusions extending inward from an inside surface of each bowl piece;
creating a base piece; and
attaching the at least two bowl pieces and the base piece together, thereby forming the vessel.
